(19) United States
(12) Patent Application Publication
(10) Pub. No.: US 2008/0267173 A1
(43) Pub. Date: Oct. 30, 2008

(54) Method for the Improved Use of an Interface System with Address Components

(75) Inventors: Stanislav Kemen, Bratislava (SK); Gerald Krautler, Wien (AT)

Correspondence Address: BELL, BOYD & LLOYD, LLP, P.O. BOX 1135, CHICAGO, IL, 60690, US

(73) Assignee: NOKIA SIEMENS NETWORKS GmbH & CO. KG

(21) Appl. No.: 12/065,470

(22) PCT Filed: Aug. 21, 2006
(86) PCT No.: PCT/EP2006/065492

§ 371 Date: Mar. 26, 2008

(30) Foreign Application Priority Data
Sep. 1, 2005 (DE) 10 2005 041 617.9

(51) Int. Cl. H04L 12/66

(52) U.S. Cl. 370/352

(57) ABSTRACT

The invention relates to a method for the improved use of an interface system (GW) for connections of subscribers (A-TIn, B-TIn) of at least two separate communications networks (KN1, KN2). During the setup of a call between subscribers (A-TIn, B-TIn), so-called virtual address components (vPL1, vPL2, vPR1, vPR2) are assigned by the interface system (GW) to each of the at least two communications networks (KN1, KN2). The virtual address components (vPL1, vPL2, vPR1, vPR2) are then signaled (23, 24) to each communications network, to which they have been assigned, and the physical address components (PL1, PL2, PR1, PR2) available in the interface system (GW) are firstly used (26, 30) when the interface system (GW) has determined that a network-external call is involved. By introducing the so-called virtual address components (vPL1, vPL2, vPR1, vPR2), the use of the interface system (GW) is improved, and a greater number of simultaneous internal calls is made possible because the virtual address components are only signaled to the communications networks (KN1, KN2) during the call setup. The interface system (GW) is thus optimally used because the address components (PL1, PL2, PR1, PR2) existing in the interface system (GW) are used only in the event of network-external calls.

### CLAIM FOR PRIORITY

This application is a 371 national stage application of PCT/EP2006/065492, filed Aug. 21, 2006, which claims the benefit of priority to German Application No. 10 2005 041 617.9, filed Sep. 1, 2005, the contents of which are hereby incorporated by reference.

### TECHNICAL FIELD OF THE INVENTION

The present invention relates to a method for the improved use of an interface system with address components, at least two separate communications networks being connected by the interface system.

### BACKGROUND OF THE INVENTION

A communications network is understood to be the generic term for all resources by means of which network access points remote from one another such as, for example, terminals are connected with one another. From these terminals, subscribers can use services with features for communications purposes which are provided by the resources of the communications network.

In this context, services provided by communications networks are, e.g. the transmission of data or voice from one terminal to another terminal so that information can be exchanged between these.

Communications networks are, for example:
Telecommunications networks which are arranged as circuit-switched networks, and
Packet-oriented networks such as, for example, data networks or, as a special form of these, networks which are based on the Internet Protocol and, in addition to data transmission, are now also used for transmitting voice.

Communications networks typically include a multiplicity of so-called network elements such as, for example, switching offices, soft switches, routers or so-called interface systems which are also-called gateways.

The network elements are connected to one another by means of physical connections which form the communication paths for data or voice. The terminals can be linked to the communications network circuit-switched—via a physical connection—or circuitless—such as, for example, in the case of mobile radio networks.

Interface systems or gateways are used at boundaries between different communications networks. An interface system provides for communication between communications networks which are based on different protocols. For this purpose, the interface system performs a protocol conversion. During the setting-up of a call between different communications networks, the interface system replaces, for example, information of one communications network with information of the other communications network.

Interface systems are also used as gateways between communications networks of different network operators such as, e.g. between an in-house communications network and a public communications network or between a fixed network and a mobile radio network. The interface system handles tasks such as, for example, charging, the conversion of different signaling procedures or speed adaptation. They also form a type of terminating point or access point to a communications network.

In order to transmit data or voice via the interface system during a communication process such as, e.g. a call, so-called address components or ports are necessary. The address components are used for correctly allocating data or voice to the services or protocols of the respective communications networks. During the transmission of data or voice from one communications network into another communications network, certain address components are used for the so-called transmission channel. For this purpose, the address components are additionally provided with numbers—the so-called port numbers.

The transmission of, for example, voice during a call which is forwarded from one communications network into another communications network therefore requires in the interface system address components for each communications network involved in the voice transmission. Firstly, the interface system reserves address components for each communications network involved in the transmission. The address components are then signaled to the respective communications networks. This means that during the setting-up of a call, the address components for the communications network to which the calling subscriber is connected are converted by the interface system into new address components for the communications network to which the called subscriber is linked.

During this process, the interface system already uses address components for the communications networks before the communications networks are informed of these by signaling. Information relating to the address components is then stored in the interface system and in a so-called registration system which is mainly used for connection and access control. If necessary, the address components can be reused—for example when carrying out call forwarding.

If, during the setting-up of the call, the interface system finds that the calling and the called subscriber are connected to different communications networks, the voice connection must be set up via the interface system. The address components already reserved and signaled are then used for transmitting the voice or data, respectively. Such a call is also-called network-external call.

If, however, the interface system finds during the setting-up of the call that the calling and called subscriber are connected to the same communications network, the voice connection can be set up directly between the two subscribers. Such a call is also-called network-internal call.

Since in the case of a network-internal call, voice or data do not need to be transmitted via the interface system, the address components already occupied and signaled are not needed in this case. Nevertheless, the address components remain occupied up to the end of the call because they could still be used, e.g. during call forwarding into another communications network, as a result of which a network-internal call becomes a network-external call. The address components are only released again after the call is ended and can be reoccupied by new calls.

Since the number of address components is limited due to the platform system of the interface system, this restricts the number of possible simultaneous calls—without distinguishing between network-internal or network-external calls. This is because the address components are occupied before it is found whether the call is network-external or network-internal.

### SUMMARY OF THE INVENTION

The present invention relates to a method by which an improved use of the address components of an interface system are achieved, and a greater number of simultaneous internal calls is supported than is possible due to the platform-system-restricted number of address components of the interface system.

According to an embodiment of the invention, there is a method for the improved use of an interface system with address components for a connection between subscribers of at least two separate communications networks, wherein virtual address components are allocated to each of the at least two communications networks by the interface system during the setting-up of a call between subscribers. The virtual address components are in each case signaled to the communications network to which they have been assigned and available physical address components of the interface system are only occupied if the interface system has found that a network-external call is involved.

One aspect according to the invention includes the introduction of so-called virtual address components which can be signaled during the call set-up but which are not occupied by any actual—i.e. physically existing—address components until it has been found whether the call is network-internal or network-external and thus whether it is actually necessary to occupy the address components in the interface system. By introducing the virtual address components with respect to which the subscriber terminals and the registration system are provided with information such as, e.g. port number etc. during the call set-up but which are not occupied before the signaling, a greater number of simultaneous internal calls are possible since these calls now no longer reserve any physical address components in the interface system. Thus, the interface system is also optimally used because the physical address components existing in the interface system are now occupied in the case of network-external calls.

In another embodiment of the invention, in the case of network-internal calls in which the subscribers are located in the same communications network, the signaled virtual address components are stored by the interface system to which the subscribers are linked, that the physical address components available in the interface system remain unoccupied and the voice connection is set up directly between the subscribers. As a result, the communication system is provided, on the one hand, with information relating to address components which, for example, can be used during a call diversion into another communications network as a result of which the call becomes a network-external call. On the other hand, as a result of a network-internal call in the case of which the voice channel is set up directly between the subscribers, no more physical address components are occupied in the interface system.

It is advantageous if in the case of network-external calls in which the subscribers are located in different communications networks, the necessary physical address components are occupied when the currently occupied address components are then made known by renewed signaling and when the voice channel is set up via the interface system. The renewed signaling informs the subscriber terminals and the registration system about the currently occupied address components of the interface system and changes the information about the virtual address components to information about those actually occupied. The voice channel for the connection between the subscribers is then set up via the interface system by using these occupied physical address components. This updated information can then be used further, for example during a call forwarding or a conference circuit.

If the call between two subscribers is changed from a network-external call to a network-internal call, it is also recommended that the occupied physical address components are released by the interface system and the interface system informs the subscriber terminals and the registration system about the virtual address components by renewed signaling. This advantageously improves the use of the interface system since the physical address components no longer needed for the call are released. These address components can then be used for other network-external calls.

The port numbers of the virtual address components can typically assume a value within the range from 0 to 65535 because the application protocols used in communications networks such as, e.g. Session Initiation Protocol SIP, etc. or switching protocols such as, for example, Internet Protocol Version 4 IPv4, Internet Protocol Version 6 IPv6, etc. are in most cases based on transport protocols such as Transmission Control Protocol TCP, User Datagram Protocol UDP or Stream Control Transmission Protocol SCTP. In these protocols, the port number is in most cases specified with a size of 16 bits and can therefore only assume a value from 0 to 65535.

### BRIEF DESCRIPTION OF THE DRAWINGS

In the text which follows, the invention will be illustratively explained with reference to the attached figures, in which:

FIG. 1 shows the sequence according to the invention in the case of a network-internal call.

FIG. 2 shows the sequence according to the invention in the case of a network-external call.

### DETAILED DESCRIPTION OF THE INVENTION

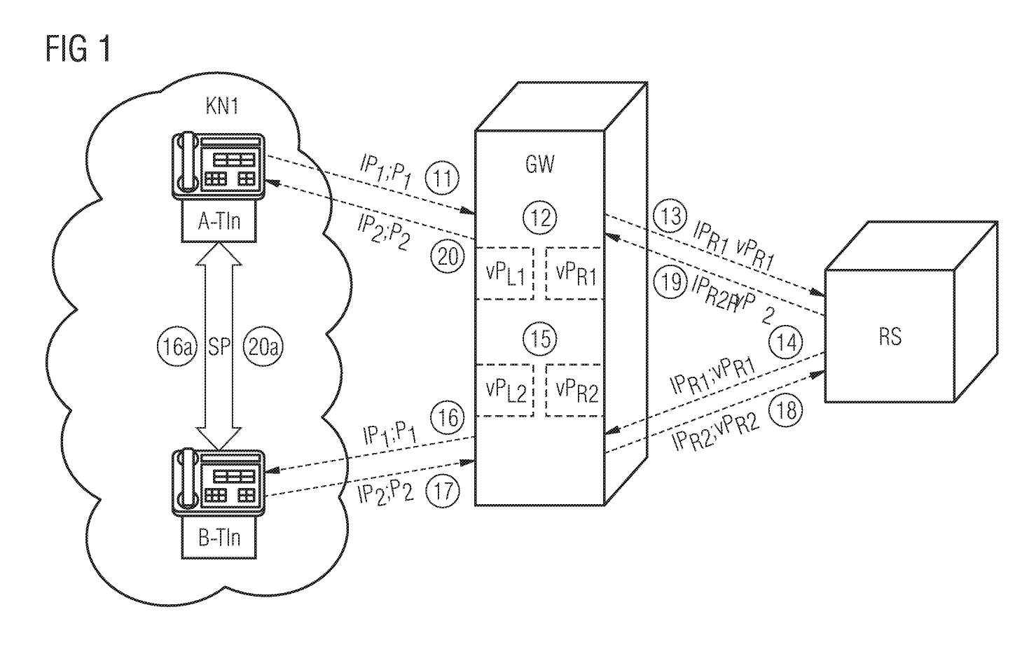

FIG. 1 shows a communications network KN1 to which exemplary subscribers A-Tln, B-Tln are connected. The connections of the two subscribers A-Tln, B-Tln are registered in an interface system GW. The two subscribers A-Tln, B-Tln could also be registered at different interface systems GW which, however, does not change the sequence of the method according to the invention, described here diagrammatically, in the case of a network-internal call.

The interface system GW comprises physical address components which are used for the actual access of the voice channel SP, and virtual address components vPL1, vPR1, vPL2, vPR2. A registration system RS is provided for registering the current position of the subscribers.

For the terminals of the subscribers A-Tln, B-Tln and for the registration system RS, the interface system GW forms a type of terminating point or access point to the communications network KN1 or, respectively, to the network to which the registration system RS is connected.

In a first step 11, the subscriber A-Tln now starts a call to the subscriber B-Tln. In this first step 11, an IP address IP1 and an address component P1 for the terminal of the subscriber A-Tln are conveyed to the interface system GW by means of signaling. In a second step 12, the interface system GW reserves virtual address components vPL1, vPR1 for this call. In this context, a virtual address component vPL1 is occupied for the terminal of the subscriber A-Tln to the interface system GW. The virtual address component vPR1 is reserved for the access from the interface system GW to the registration system RS.

In a third step 13, the registration system RS is informed by the interface system GW about an IP address IPR1 and the virtual address component vPR1 by means of signaling, the IP address IPR1 being used as access address for the registration system RS to the interface system GW for the terminal of the subscriber A-Tln.

In a fourth step 14, the IP address IPR1 and the virtual address component vPR1 are signaled by the registration system RS to part of the interface system GW which deals with the access to the terminal of the subscriber B-Tln, and are stored there. If the subscriber B-Tln were not registered at the same interface system GW as the subscriber A-Tln, the registration system RS would in this case signal the IP address IPR1 and the virtual address component vPR1 to the further interface system GW.

In a fifth step 15, virtual address components vPL2, vPR2 are reserved for this call by the interface system GW. In this context, a virtual address component vPL2 is occupied for the terminal of the subscriber B-Tln to the interface system GW. The virtual address component vPR2 is reserved for the access from the interface system GW to the registration system RS.

If then the interface system GW finds in a sixth step 16 that the two subscribers A-Tln and B-Tln are connected to the same communications network KN1, the interface system GW immediately signals the IP address IP1 and the address component P1 for the terminal of the subscriber A-Tln to the terminal of the subscriber B-Tln. At the same time, the voice channel SP for the call is set up directly within the communications network KN1 from the terminal of the subscriber B-Tln in the direction of the terminal of the subscriber A-Tln in a step 16a.

In a seventh step 17, an IP address IP2 and an address component P2 for the terminal of the subscriber B-Tln are then transmitted by the subscriber B-Tln to the interface system GW by means of signaling. In an eighth step 18, an IP address IPR2 and the virtual address component vPR2 are then signaled to the registration system RS by the interface system GW, the IP address IPR2 being used as access address for the registration system RS to the interface system GW for the terminal of the subscriber B-Tln. The IP address IPR2 and the virtual address component vPR2 are then sent by the registration system RS by means of signaling in a ninth step 19 to a part of the interface system GW which deals with the access to the terminal of the subscriber A-Tln, and are stored there. If the subscribers A-Tln and B-Tln were not registered at the same interface system GW, the registration system RS would then signal the IP address IPR2 and the virtual address component vPR2 in this ninth step 19 to the interface system GW in which the subscriber A-Tln is registered. If then the interface system GW recognizes again in a tenth step 20 that the subscribers A-Tln and B-Tln are connected to the same communications network KN1, the IP address IP2 and an address component P2 for the terminal of the subscriber B-Tln is directly signaled to the terminal of the subscriber A-Tln. At the same time, the voice channel SP for the call is set up directly within the communications network KN1 from the terminal of the subscriber A-Tln in the direction of the terminal of the subscriber B-Tln in a step 20a. The voice channel is set up in both directions.

Steps 17 to 20 in which the signaling from the terminal of subscriber B-Tln via the interface system GW and the registration system RS to the terminal of subscriber A-Tln is carried out can be run not only after steps 14 to 16 in time but these steps 17 to 20 can also be run in parallel with steps 14 to 16 depending on the protocol for signaling used. This does not result in any change for the method according to the invention in the case of network-internal call.

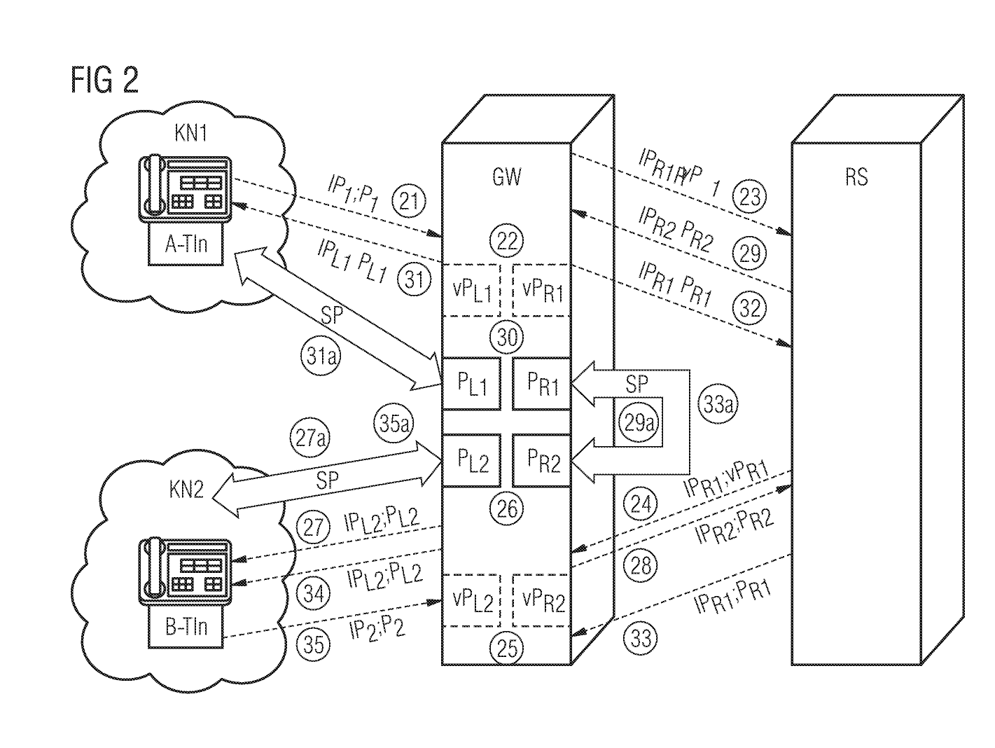

FIG. 2 again shows the communications network KN1 to which, however, only subscriber A-Tln is linked. Subscriber B-Tln is now connected to a second communications network KN2. The connections of the two subscribers A-Tln, B-Tln are again registered at an interface system GW. In this case, too, the two subscribers A-Tln, B-Tln could be registered at different interface systems GW but this does not change the sequence, described diagrammatically here, of the method according to the invention in the case of a network-external call.

The interface system GW comprises physical address components PL1, PL2, PR1, PR2 and virtual address components vPL1, VPR1, vPL2, vPR2. A registration system RS is also provided for registering the current position of the subscribers.

If then subscriber A-Tln sets up a call to subscriber B-Tln in a first step 21, the IP address IP1 and address component P1 for the terminal of subscriber A-Tln are again conveyed to the interface system GW by means of signaling in this first step 21.

In a second step 22, the interface system GW now reserves the virtual address components vPL1, vPR1 for this call—as already in the case of the network-internal call—as corresponding accesses for the terminal of subscriber A-Tln or these, respectively, for the registration system RS.

In a third step 23, the registration system RS is now again informed by the interface system GW about the IP address IPR1 and the virtual address component vPR1 for the access information to the interface system GW for the terminal of subscriber A-Tln. This IP address IPR1 and the virtual address component vPR1 is then signaled again in a fourth step 24 by the registration system RS to a part of the interface system GW which deals with the access to the terminal of the subscriber B-Tln or in the case of a different interface system GW, for the subscriber B-Tln and is stored there.

In a fifth step 25, the interface system GW now reserves—as already in the case of the network-internal call—the virtual address components vPL2, vPR2 for this call as corresponding accesses for the terminal of the subscriber B-Tln or, respectively, for the registration system RS. If then in a sixth step 26, the interface system GW recognizes that the two subscribers A-Tln and B-Tln are linked to different communications networks KN1, KN2, physical address components PL2, PR2 available for the call are occupied in this sixth step 26. The virtual address components vPL2, vPR2 are thus replaced by the physical address components PL2, PR2 for this call, the physical address component PL2 being reserved as access for the voice channel for the terminal of subscriber B-Tln. Address component PR2 is occupied for the access from the direction of the registration system RS.

In a seventh step 27, the IP address IPL2 and the physical address component PL2 are then immediately signaled for the access from the interface system GW to the terminal of the subscriber B-Tln. The voice connection between the terminal of the subscriber B-Tln and the interface system GW is established in parallel with this seventh step 27 in a step 27a.

In an eighth step 28, the interface system GW performs renewed signaling to the registration system RS by means of which the registration system RS is now informed about the physical address component PR2 for the access to the interface system GW in addition to the IP address IPR2. In a ninth step 29, the information about the physical address component PR2 is then sent, in addition to the IP address IPR2, to the part of interface system GW which deals with the access to the terminal of the subscriber A-Tln by the registration system RS by means of a further new signaling step so that the information about the physical address component PR2 is available in the interface system GW. The information stored in the interface system GW about the virtual address component vPR2 for the call is replaced by the information about the physical address component PR2. In the case of different interface system GW for the subscribers A-Tln, B-Tln, the data (IP address IPR2 and physical address component PL2) would be transmitted to the further interface system GW.

In parallel with the ninth step 29, the voice connection from the part of the interface system which deals with the access from the terminal of subscriber A-Tln is established in a step 29a to the part of the interface system which deals with the access from the terminal of subscriber B-Tln.

If the interface system GW then recognizes in a tenth step 30 that the two subscribers A-Tln and B-Tln are linked to different communications networks KN1, KN2, physical address components PL1, PR1 available for the call are occupied in this tenth step 30. The virtual address components vPL1, vPR1 are thus replaced by physical address components PL1, PR1 for this call, the physical address component PL1 being reserved as access for the voice channel for the terminal of subscriber A-Tln. The address component PR1 is occupied for the access from the direction of the registration system RS.

In an eleventh step 31, the IP address IPL1 and the physical address component PL1 for the access from the interface system GW are then immediately signaled to the terminal of the subscriber A-Tln and, in parallel, in a step 31a the voice connection is established between the terminal of subscriber A-Tln and the interface system GW.

In a twelfth step 32, the interface system GW performs renewed signaling to the registration system RS by means of which the registration system RS is informed about, in addition to the IP address IPR1, the physical address component PR1 for the access to the interface system GW. In a thirteenth step 33, the information about the physical address component PR1 is then sent, in addition to the IP address IPR1, from the registration system RS to the part of the interface system GW which deals with the access to the terminal of the subscriber B-Tln by a further new signaling step so that the information about the physical address component PR1 is available in the interface system GW. The information about the virtual address component vPR1 for the call, stored in the interface system GW, is replaced by the information about the physical address component PR1 in this process.

In the case of different interface system GW for the subscribers A-Tln, B-Tln the data (IP address IPR1 and physical address component PR1) would be transmitted to the further interface system GW.

In parallel with the thirteenth step 33, the voice connection from the part of the interface system which deals with the access from the terminal of the subscriber B-Tln to the part of the interface system which deals with the access from the terminal of the subscriber A-Tln is still established in a step 33a.

In a fourteenth step 34, the IP address IPL2 and the physical address component PL2 for the access from the interface system GW to the terminal of the subscriber B-Tln can be signaled again.

In a fifteenth step, the terminal of subscriber B-Tln conveys the IP address IP2 and the address component P2 to the interface system GW by means of signaling, by means of which the voice connection between the interface system and the terminal of subscriber B-Tln is also established in a parallel step 35a. By means of steps 27a, 29a, 31a, 33a, 35a, the voice channel SP is set up for the call between subscribers A-Tln and B-Tln via the physical address components PL1, PL2, PR1, PR2 of the interface system.

The link of the voice connection no longer changes even if the interface system repeats steps 28, 29 and possibly even 31 on the basis of step 35.

The method can also be used for cases in which network-external calls become network-internal calls or conversely, for example due to call forwarding or conference circuit.

In the case where a network-external call becomes a network-internal call, the physical address components PL1, PL2, PR1, PR2 occupied are released. The registration system RS and the terminals of subscribers A-Tln, B-Tln are then informed about virtual address components vPL1, vPR1, vPL2, vPR2 by means of renewed signaling.

If a network-internal call becomes a network-external call, steps 26 to 34 are run as shown in FIG. 2 once the interface system GW has found that subscribers A-Tln, B-Tln are located in different communications networks KN1, KN2.

1. A method for connecting subscribers of an interface system with address components in at least two separate communications networks, comprising:
allocating, during the setting-up of a call between subscribers, virtual address components to each of the at least two communications networks;
signaling the virtual address components to the communications network to which they have been assigned; and
occupying available physical address components of the interface system if the interface system has found that a network-external call is involved.

2. The method as claimed in claim 1, wherein when network-internal calls in which the subscribers are located within the same communications network, the signaled virtual address components are stored by the interface system at which the subscribers are registered, the physical address components available in the interface system remain unoccupied and the voice channel is set up directly between the subscribers.

3. The method as claimed in claim 1, wherein when network-external calls in which the subscribers are located in different communications networks, the necessary physical address components are occupied, the currently occupied address components are made known are renewed signaling and the voice channel is set up via the interface system.

4. The method as claimed in claim 1, wherein if the call between two subscribers is changed from a network-external call to a network-internal call, the occupied physical address components are released by the interface system and the interface system signals the virtual address components.

5. The method as claimed in claim 1, wherein the port numbers of the virtual address components can assume a value within the range from 0 to 65535.
